(19) United States
(12) Patent Application Publication
(10) Pub. No.: US 2002/0096119 A1
(43) Pub. Date: Jul. 25, 2002

(54) Pet Chair

(76) Inventor: Kevin L. Kolozsvari, Tustin, CA (US)

Correspondence Address: Richard E. Bee, Weinberg Legal Group, Suite 250, 2390 East Camelback Road, Phoenix, AZ, 85016, US

(21) Appl. No.: 09/768,370

(22) Filed: Jan. 23, 2001

(51) Int. Cl. A01K 29/00

(52) U.S. Cl. 119/28.5

(57) ABSTRACT

A collapsible pet chair for dogs and cats which is comfortable, sturdy, easy to use and attractive in appearance. This pet chair includes a four-cornered chair cover having attachment pockets at the four corners thereof. It also includes a metal rod support frame having upwardly extending support members for engaging the attachment pockets and downwardly extending leg members for engaging a support surface such as the floor. The support frame is provided with pivotal joints for enabling the support frame to be placed in a collapsed condition for transportation or storage.

### DESCRIPTION

1. Technical Field

This invention relates to chairs for pets such as cats and small dogs.

2. Background of the Invention

Dogs and cats sometimes us people furniture for purposes of sitting or resting. Such furniture includes sofas, club chairs, easy chairs and the like. This has various disadvantages. The pet may leave dirt or animal hairs on the furniture. In some cases, the pet may leave fleas or ticks or various parasites on the furniture. These problems can be avoided by providing the pet with his or her own chair. This may also improve the animal's quality of life by having a place to sit where he or she won't get fussed at or asked to move.

### SUMMARY OF THE INVENTION

The present invention provides a chair for dogs and cats which is comfortable, sturdy, easy to use and attractive in appearance. The chair is also collapsible into a compact bundle to facilitate its transportation or storage. The pet chair of the present invention includes a four-cornered chair cover having attachment pockets at the four corners thereof. It also includes a support frame having upwardly extending support members for engaging the attachment pockets and downwardly extending leg members for engaging a support surface such as the floor. The support frame is provided with pivotal joints for enabling the support frame to be placed in a collapsed condition for transportation or storage.

For a better understanding of the present invention, together with other and further advantages and features thereof, reference is made to the following description taken in connection with the accompanying drawings, the scope of the invention being pointed out in the appended claims.

### BRIEF DESCRIPTION OF THE DRAWINGS

Referring to the drawings:

FIG. 1 is a perspective view of a pet chair constructed in accordance with the present invention and showing a cat sitting in the chair;

FIG. 2 is a perspective view similar to FIG. 1 and showing the location of a cushion in the chair;

FIG. 3 is a plan view of the chair cover used on the FIG. 1 chair;

FIG. 4 is a perspective view of the removable cushion shown in FIG. 2;

FIG. 5 is a perspective view of the support frame portion of the FIG. 1 chair;

FIG. 6 is a perspective view showing the support frame of FIG. 5 in a collapsed or retracted condition;

FIG. 7 is an enlarged view of one of the pivotal connectors used on the support frame of FIG. 5 for interconnecting adjoining segments of the wing members;

FIG. 8 is an enlarged view of one of the inter-wing pivotal connectors used on the support frame of FIG. 5;

FIG. 9 is a perspective view of a pair of wing members used in the support frame of FIG. 5;

FIG. 10 is a side view from the right of the pair of wing members shown in FIG. 9; and

FIG. 11 is a top view of the support frame of FIG. 5.

### DETAILED DESCRIPTION OF THE ILLUSTRATED EMBODIMENT

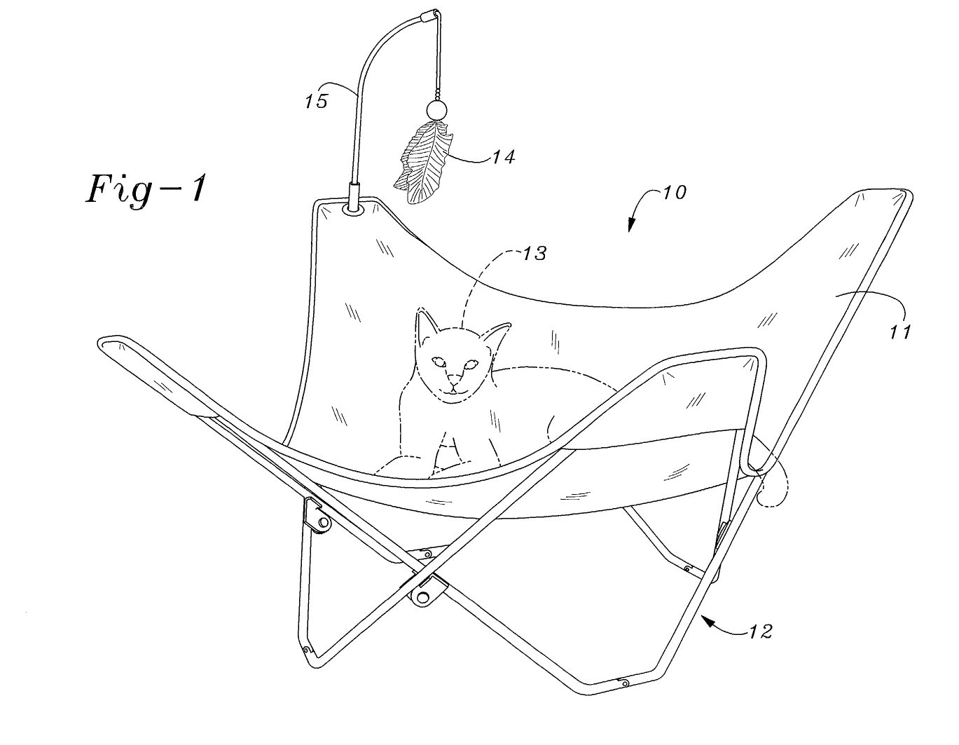

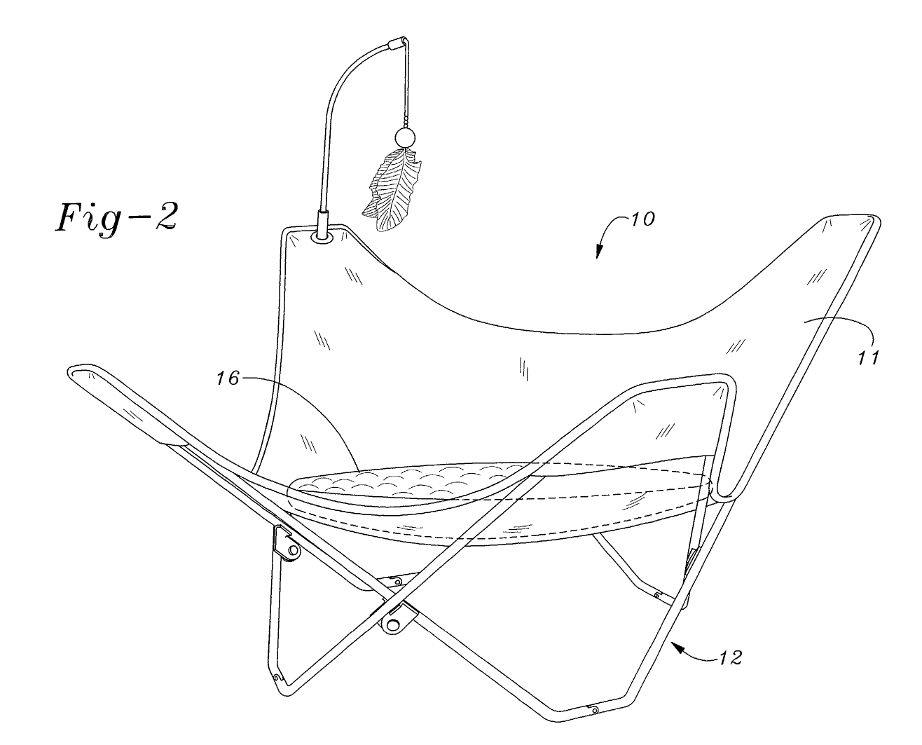

Referring to FIG. 1, there is shown a representative embodiment of a pet chair constructed in accordance with the present invention. This pet chair 10 includes a four-cornered chair cover 11 and a support frame 12 for suspending the chair cover 11 in an elevated position. A cat 13 is shown laying in the pet chair 10. A plaything 14 is suspended over the chair cover 11 by a bent rod 15 which is clamped to an upper portion of the support frame 12. FIG. 2 is similar to FIG. 1, but with the cat removed. FIG. 2 shows the location of a removable cushion 16 in the cradle formed by the chair cover 11.

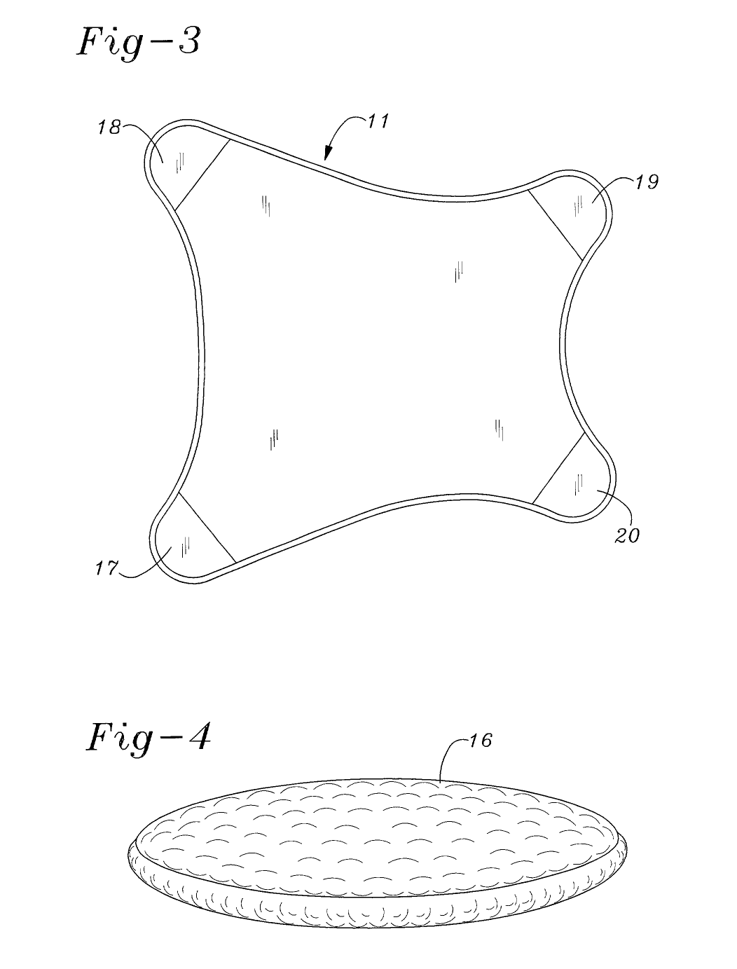

FIG. 3 shows a plan view of the underside of the four-cornered chair cover 11. As there seen, chair cover 11 has attachment pockets 17-20 individually located at different ones of the four corners thereof. The open sides of these pockets face toward the center of chair cover 11. FIG. 4 shows a perspective view of the removable cushion 16 of FIG. 2.

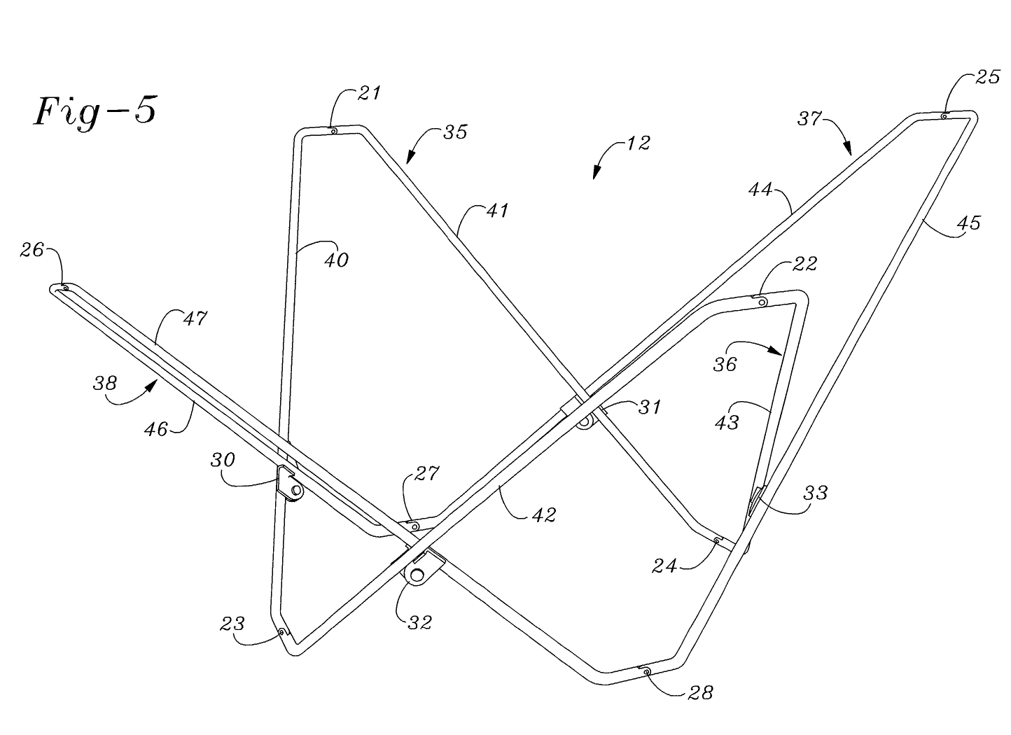

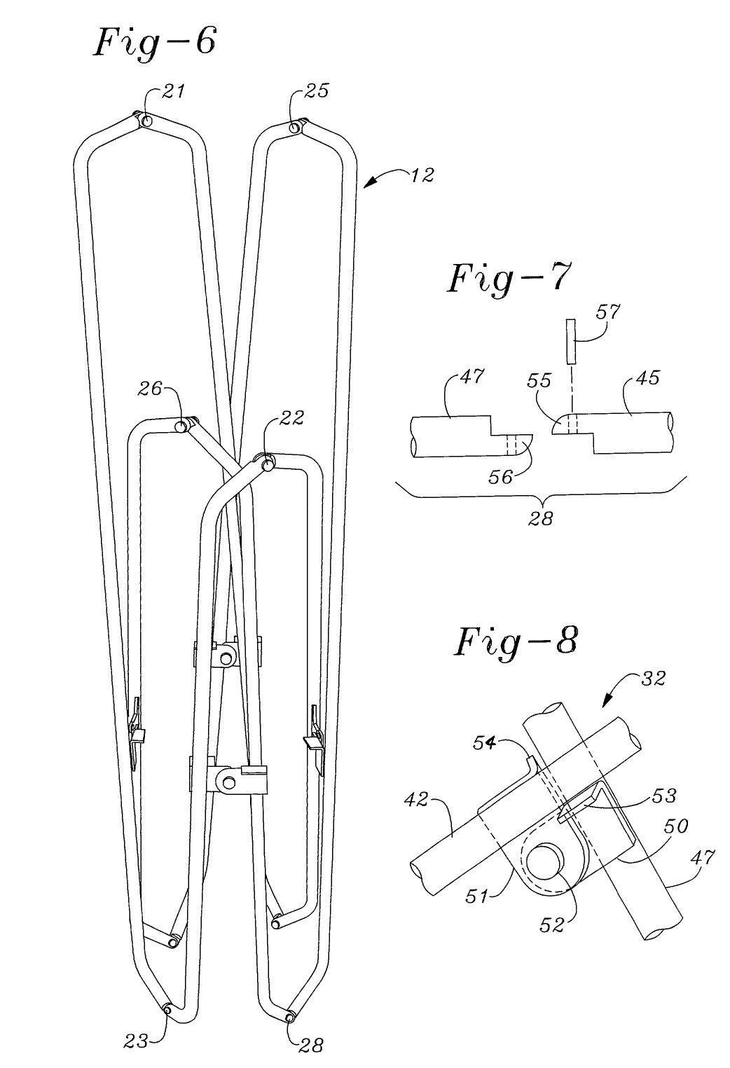

FIG. 5 shows a perspective view of the support frame 12 of FIG. 1 with the chair cover 11 removed. The various parts of support frame 12 are made of interconnected shaped steel rods. Twelve pivotal joints 21-28 and 30-33 are provided to interconnect the different segments of the support frame 12. These pivotal joints enable support frame 12 to be placed in a collapsed condition for facilitating transportation and storage of the pet chair 10. This collapsed condition is shown in FIG. 6.

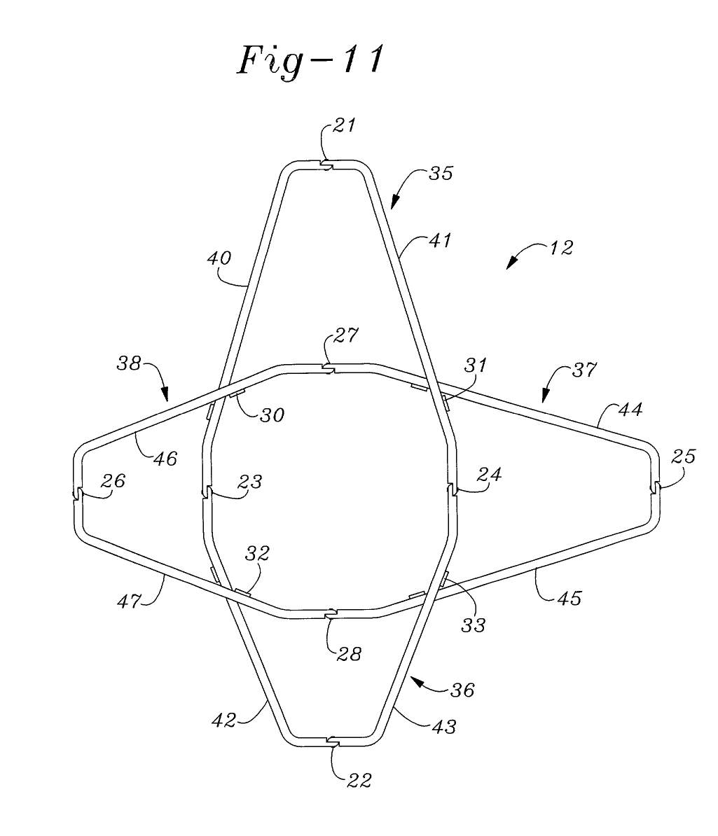

A top view of the support frame 12 of FIG. 5 is shown in FIG. 11. FIG. 11 is useful for keeping track of the different parts of the support frame 12.

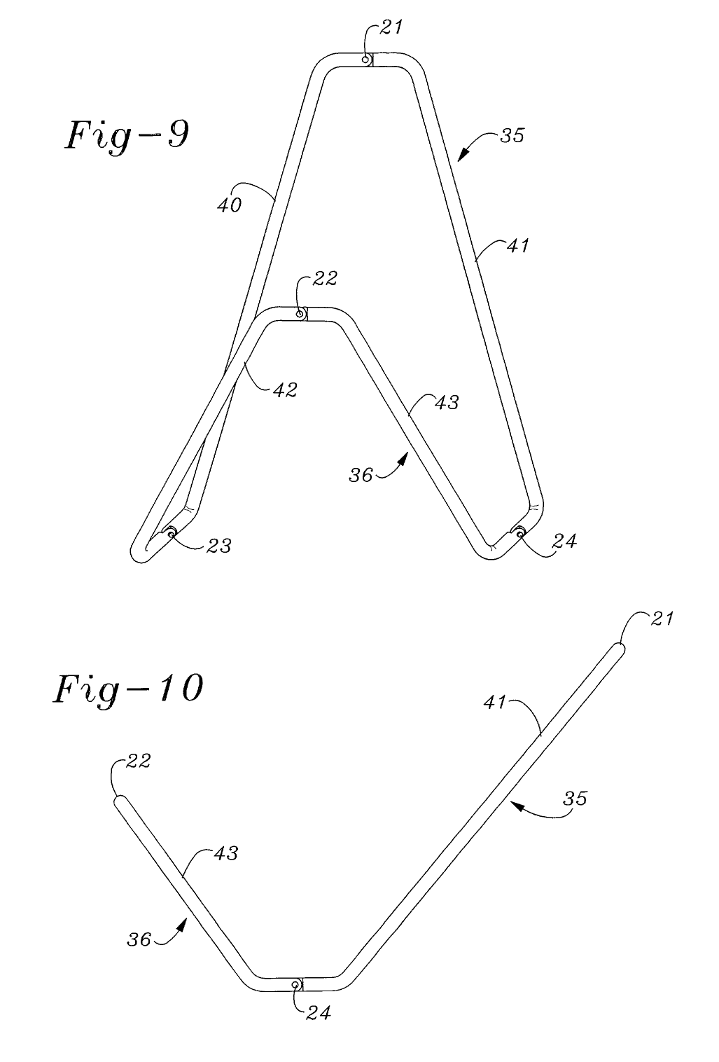

With reference to FIGS. 5 and 11, the support frame 12 includes a first pair of wing members 35 and 36 which extend upwardly at divergent angles to engage attachment pockets 18 and 20 on a first set of opposite corners of the chair cover 11. A perspective view of this pair of wing members 35 and 36 is shown in FIG. 9. FIG. 10 shows an end view of the FIG. 9 structure and clearly shows the divergent angles at which wing members 35 and 36 extend. It is also noted that wing member 36 is somewhat shorter in length than wing member 35. Wing member 35 includes segments 40 and 41 interconnected at their upper ends by pivotal connector 21. Wing member 36 includes segments 42 and 43 interconnected at their top ends by pivotal connector 22. As seen in FIG. 9, pivotal connectors 23 and 24 are located at the lower ends of wing members 35 and 36 for connecting the lower ends of these opposing wing members 35 and 36 to one another.

The support frame 12 further includes a second pair of wing members 37 and 38 oriented at ninety degrees relative to the first pair 35 and 36 and nested in the first pair 35 and 36. This second pair extends upwardly at divergent angles to engage attachment pockets 17 and 19 on a second set of opposite corners of the chair cover 11. Wing member 38 is somewhat shorter than wing member 37. Wing member 37 includes segments 44 and 45 interconnected at their upper ends by pivotal connector 25. Wing member 38 includes segments 46 and 47 interconnected at their upper ends by pivotal connector 26. The lower ends of wing members 37 and 38 are connected to one another by pivotal connectors 27 and 28.

As seen in FIG. 5, each of the wing members 35-38 is in the shape of an arch.

An inter-wing pivotal connector is located at each point where a wing member from the first pair 35 and 36 contacts a wing member from the second pair 37 and 38. There are four such points, as represented by the locations of inter-wing connectors 30-33. Considering, for example, the case of inter-wing connector 32, it serves to pivotally clamp segment 42 of wing member 36 to segment 47 of wing member 38.

The enlarged view of FIG. 8 shows in greater detail the construction of one of the inter-wing pivotal connectors 30-33, namely, the connector 32 which attaches wing segment 42 to wing segment 47. Connector 32 has a small plate member 50 welded to the side of wing segment 47. A second small plate member 51 is welded to the side of the other wing segment 42 so as to extend along side the first plate member 50. Both of plates 50 and 51 have bolt holes which are in alignment with one another. A bolt 52 is inserted through these holes and is bolted in place on the far side of plate 50. Flanges 53 and 54 on plates 50 and 51, respectively, extend outward a short distance and function as stops to limit the maximum divergence of their respective wing segments 47 and 42 by engaging the side of the other wing segment. These stops prevent undue stress on the chair cover 11. The other inter-wing connectors 30, 31 and 33 are of this same construction.

The enlarged view of FIG. 7 shows in greater detail the construction of one of the pivotal connectors 21-28 which interconnect the ends of adjoining wing segments. Using connector 28 as an example, the adjoining ends of wing segments 45 and 47 are cut to provide overlapping tabs 55 and 56. A connecting bolt 57 is passed through aligned center holes in tabs 55 and 56 and bolted in place on the far side of tab 56. The other pivotal connectors 21-27 are of this same construction.

FIG. 6 is a perspective view showing the support frame 12 of FIG. 5 in a collapsed condition. When collapsed, support frame 12 provides a compact bundle which facilitates transportation or storage of the pet chair 10. The various pivotal connectors 21-28 and 30-33 enable the frame members to be brought together to provide a compact bundle.

While there has been described what is at present considered to be a preferred embodiment of this invention, it will be obvious to those skilled in the art that various changes and modifications may be made therein without departing from the invention and it is, therefore, intended to cover all such changes and modifications as come within the true spirit and scope of the invention.

What is claimed is:

1. A collapsible pet chair for a cat or small dog comprising:
a four-cornered chair cover having attachment pockets at the four corners thereof;
and a support frame having upwardly extending support members for engaging the attachment pockets and downwardly extending leg members for engaging a support surface;
the support frame having pivotal joints for enabling the support frame to be placed in a collapsed condition for transportation or storage.

2. A collapsible pet chair in accordance with claim 1 wherein the chair cover is sized and shaped to accommodate the body of an adult cat.

3. A collapsible pet chair in accordance with claim 1 wherein the support members and the leg members are made of shaped steel rods.

4. A collapsible pet chair in accordance with claim 1 wherein the support frame has at least twelve pivotal joints.

5. A pet chair for a cat or small dog comprising:
a four-cornered chair cover having attachment pockets at the four corners thereof;
a first pair of wing members which extend upwardly at divergent angles to engage attachment pockets on a first set of opposite corners of the chair cover;
and a second pair of wing members oriented at ninety degrees relative to the first pair and nested in the first pair and extending upwardly at divergent angles to engage attachment pockets on a second set of opposite corners of the chair cover.

6. A pet chair in accordance with claim 5 wherein the wing members are arch shaped.

7. A pet chair in accordance with claim 5 wherein the lower ends of the two wing members in each pair are connected to one another.

8. A pet chair in accordance with claim 5 wherein the wing members have pivotal joints for enabling the wing members to be placed in a collapsed condition for transportation or storage.

9. A pet chair in accordance with claim 5 wherein an inter-wing pivotal connector is located at each point where a wing member from the first pair contacts a wing member from the second pair for pivotally clamping the contacting wing members together.

10. A pet chair in accordance with claim 9 wherein each inter-wing pivotal connector includes a stop member for limiting the maximum divergence of the wing members in each pair relative to one another to prevent undue stress on the chair cover.

11. A pet chair in accordance with claim 5 and including pivotal connectors interconnecting different segments of each wing member for enabling the wing members to be placed in retracted positions for transportation or storage.

12. A pet chair in accordance with claim 11 wherein a pivotal connecter is located at the top of each wing member for connecting together the two sides of each wing member and pivotal connectors are located at the lower ends of each wing member for connecting the lower ends of opposing wing members to one another.

13. A pet chair in accordance with claim 12 and having inter-wing pivotal connectors located at points where a wing member from the first pair contacts a wing member from the second pair for pivotally clamping the contacting wing members together.
